(19) United States
(12) Patent Application Publication
(10) Pub. No.: US 2004/0096546 A1
(43) Pub. Date: May 20, 2004

(54) Fat-containing milk substitute for young stock, method for preparing the fat-containing milk substitute and device to be used therewith

(76) Inventor: Hubert Jean-Marie Francois Gillessen, Lanaken (BE)

Correspondence Address: Peter W. Gowdey, Shook, Hardy & Bacon LLP, Suite 800, 600 14th Street, NW, Washington, DC, 20005, US

(21) Appl. No.: 10/293,493

(22) Filed: Nov. 14, 2002

(51) Int. Cl. A23L 1/28

(52) U.S. Cl. 426/61

(57) ABSTRACT

The present invention relates to a fat-containing milk substitute for young stock, such as calves, and for poultry, consisting of a particulate basic component which contains fat, in which more than 50 wt. % of the fat has been introduced into the capillaries of the basic component, with less than 50 wt. % of the fat being present at the surface of the particles of the basic component. The invention furthermore relates to the method for preparing said fat-containing milk substitute for young stock, such as calves, and for poultry, by mixing fat with the particles of the basic component of the milk substitute and introducing fat into the basic component at an elevated temperature and under a reduced pressure. The invention also relates to a device for carrying out said method,

### DESCRIPTION

The invention relates to a fat-containing milk substitute consisting of a particulate basic component which contains fat. The invention furthermore relates to a method for preparing a fat-containing milk substitute for young stock by mixing fat with the particles of the basic component of the milk substitute. More in particular, the invention relates to a method for preparing granulated milk substitutes, which milk substitute contains fat. Furthermore, the invention relates to a device for carrying out the method according to the invention.

Young stock, such as (feeding) calves, lambs and piglets, and poultry, such as (feeding) ducks, geese and laying hens are fed on high-energy and high-protein feedstuffs, in particular milk or milk substitutes. Such milk substitutes have a base of a powdery component which is mixed with water. The basic component comprises, among other substances, dairy produce and/or other vegetable or animal raw substances in powder form. The basic component may also contain other auxiliary substances, such as minerals and vitamin supplements. Furthermore, fats of vegetable and/or animal origin and/or fish are added to the milk substitute. Fats may in turn contain certain auxiliary substances. The aim in developing a milk substitute is to increase the fat content of the particulate basic component such as milk powder, dried whey, and vegetable substances from 15% to 50%.

Although it is possible to give powder particles a higher weight percentage of fat at the surface thereof than has been usual so far, such a higher fat content leads to digestive problems with the young stock or poultry. Consequently, the aim of the new products and the new process is to achieve a higher amount of fat on or in the powdery raw material than has been possible with the techniques that have been used so far, modifying the product in such a manner that a better absorption of the fat will take place.

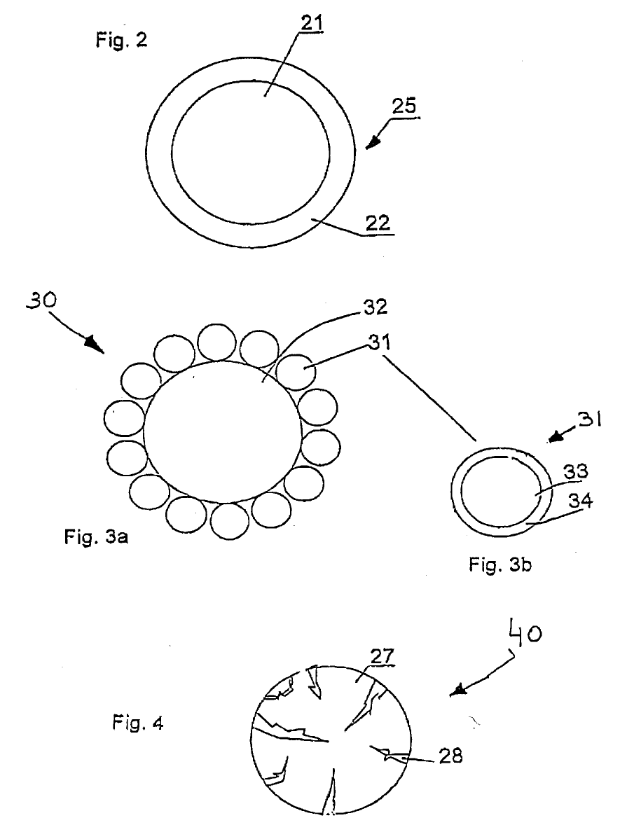

From practice it is known to coat a powder particle with a layer of fat by means of a rolling process, for example. In this way, a fat-containing powder particle as shown in FIG. 2 is obtained, as will be discussed hereinafter. Furthermore it is known from practice to obtain a fat-containing powder by spray-drying or spray-cooling, as is shown in the FIGS. 3a and 3b that will be discussed hereinafter, wherein the fat particle is surrounded by powder particles, thus forming an agglomerate in which a fat particle is surrounded by a large number of powder particles and vice versa. Thus, a readily flowable product is obtained, which has this drawback, however, that it is difficult to digest for young stock or poultry, especially in the case of products having a fat content of more than 20%. These known fat-containing powdery products are improved by providing a product according to the invention.

The aim in developing new milk substitutes is to increase the fat content of the particulate basic component, such as milk powder, in particular to a fat content of more than 20 wt. %. As indicated above, it is possible to give particles of milk powder a higher weight percentage of fat at the surface thereof, but such a higher fat content at the surface leads to digestive problems with the young stock or poultry. The term young stock, when used hereinafter, is understood to include poultry as well.

Intensive research has led to the development of a new product and a new method, wherein it is possible for the fat to be introduced into the core of the particle in large measure, with a small amount of fat being present at the surface of the particle.

It has become apparent, using the method and the device according to the invention, to prepare a fat-containing milk substitute for young stock and (feeding) calves, which milk substitute contains the desired auxiliary substances, in particular fat, so that high percentages of fat and auxiliary substances (over 20 wt. %) can be administered to the young stock without this leading to problems as regards the ingestion of the feed by the young stock.

The fat-containing milk substitute according to the invention is characterized in that more than 50 wt. % of the fat has been introduced into the capillaries of the basic component, with less than 50 wt. % of the fat being present at the surface of the particles of the basic component. In particular, the capillaries of the particles of the basic component contain more than 90 wt. % of the fat, with less than 10 wt. % of the fat being present at the surface of the particle of the basic component.

Preferably, milk powder is used as the basic component. Also dried whey and starches can be used, and the basic component/fat weight ratio is higher than 1:1 and lower than 100:1. More in particular, the powder/fat weight ratio ranges between 1:0.5 and 1:0.1.

Preferably, more than 90 wt. % of the fat is introduced into the capillaries of the powder particle.

With the method according to the invention, the fat is mixed with the powder under a reduced pressure and at an elevated temperature. In particular, the reduced pressure is 0.2-0.7 bar and the elevated temperature is 25-60° C.

In order to enable proper processing of the obtained fat-containing powder particles into a milk substitute at a later stage, it is preferred to obtain particles having a grain size of about 1.5-4 mm. To that end, the obtained particles are screened after the addition of the fat and subsequently stored at a reduced temperature, in particular a temperature of less than 8° C. Prior to cooling, the screened particles are mixed with solid carbon dioxide, which will evaporate when air is blown in, thus cooling down the obtained grains to said reduced temperature.

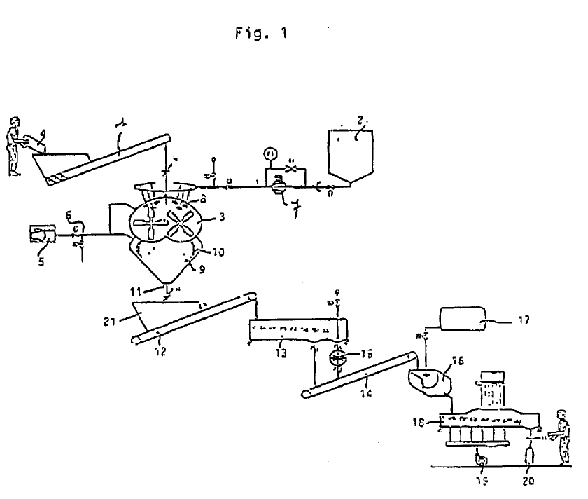

The device according to the invention will be described in more detail hereinafter with reference to FIG. 1 of the appended drawing. The drawing also shows the known product in FIGS. 2, 3a and 3b; the product according to the invention is shown in FIG. 4.

It is generally known to introduce auxiliary substances under the surface of the basic component of fish feed by means of oil when preparing particles of said fish feed, which is done by using a method which employs a reduced pressure. In this connection, reference is made to European patent application No 0 556 883.

The invention will be explained in more detail hereinafter in the following description, in which reference is made to the appended drawing, in which:

FIG. 1 shows a device for carrying out the method for preparing a fat-containing milk substitute;

FIG. 2 shows the fat-containing powder particle, which has been obtained by means of using cooling rolls;

FIGS. 3a and 3b show a fat-containing powdery product obtained by means of a spray-drying process; and

FIG. 4 shows the fat-containing powder particle obtained in accordance with the invention.

A known fat-containing powder particle is shown at 25 in FIG. 2, in which the powder particle 21 is surrounded by a fat envelope 22. This product has been obtained by means of using cooling rolls.

FIG. 3 (consisting of FIGS. 3a and 3b) shows in FIG. 3a the agglomerate 30, which in turn consists of fat particles 32 surrounded by powder particles 31. Said powder particles 31 are shown separately in FIG. 3b, in which the powder particle 33 is surrounded by a thin skin 34 of fat.

In FIG. 4, the product according to the invention is shown at 40, in which the powder particle 27 comprises capillaries 28 which will be filled with fat once the method according to the invention has been carried out. It will be apparent that the powder particle that is shown in FIGS. 2 and 3 also comprises capillaries, but said capillaries do not comprise fat, or only on the outside, whereas according to the invention the powder particle 27 comprises fat-filled capillaries 28. The milk substitute according to the invention that has thus been obtained is more easily digested by young stock and larger quantities of fat can be administered via powder without this leading to problems with the young stock as regards the ingestion of the substances to be administered in the fat and the fat itself. Consequently, the product according to the invention makes it possible to obtain a milk substitute for young stock by means of which in addition to milk powder, amongst other substances, also fat and auxiliary substances can be administered to the young cattle without this leading to digestive problems when relatively high percentages of fat (above 20 wt. %) are used.

Explaining the device to be used as shown in FIG. 1 in more detail now, sacks 4 filled with a powder, preferably milk powder, are emptied into a screw conveyor 1. The powder has a loose, dusty structure and an ambient temperature, viz. about 15° C. In this way, 100 kg of powder are added to the mixer 3 via the screw conveyor 1.

After the mixer has been filled with 100 kg of powder, the mixer 3 is closed and a sub-atmospheric pressure of about 0.5 bar is generated in the mixer via the vacuum pump 5. After the sub-atmospheric pressure has been reached within 1.5 minutes, the mixer is closed by means of the valve 6 and the operation of the vacuum pump 5 is stopped. Subsequently, the screw blades in the mixer 3 are rotated and fat from the storage container 2 is supplied to the powder, via the nozzles 8, by means of the pump 7. The temperature of the fat in the storage container 2 is 45° C. Within one minute, 40 l of fat are added to the rotating powder, so that the final product will contain about 25% fat. After 40 l of hot fat have been supplied to the mixer, the nozzles 8 are blown through and the sub-atmospheric pressure is released and the mixer is stopped. Then the hatch 10 of the mixer is opened and the powder, to which fat has been added, runs into the lower bunker 9. Following that, the bottom valve 11 of the bunker is opened and the fat-containing powder falls into a receiving bin above the conveyor belt 12. The temperature of the product placed onto the conveyor belt 12 is about 26° C. The granular product is transferred to a (Locker) screen 13 via the conveyor belt 12. Said screen comprises a screen frame with an upper cloth having a screen mesh of 8 mm. A small part (less than 10%) of the grains falls through the screen onto a discharge conveyor 14. The main part of the grains runs over the screening cloth, forming balls having a size of 2-3 cm. Said balls fall into a milling cutter 15, in which they are crushed fine. The substances being discharged from the screen 13 and from the milling cutter 15 (smaller than 8 mm) are transferred to the flow-through mixer 16 via the discharge conveyor 14, in which mixer the substances are mixed with solid flakes of carbon dioxide. To this end, liquid carbon dioxide from container 17 is converted into a spray, from which solid flakes are formed, which flakes are spread between chunks or balls of product, The product in the form of a mixture of flakes and balls lands on the flat screen 18. At the bottom side of the flat screen/fluidising bed 18 air is supplied via the fan 19, causing the CO₂ flakes to evaporate, so that heat is withdrawn from the product, as a result of which it will cool down to a temperature of about 5° C. This cooled product is collected in sacks 20 or in a hopper (not shown), thus obtaining the final product. Upon analysis of the final product it appears that the final product consists of chunks of powder having a size of maximally 1 cm³ and containing about 25% fat. More than half of said fat has been introduced into the core of the chunk-shaped product, with less than half of the fat being present at the surface. This product makes it possible to obtain a milk substitute for young stock, by means of which not only powder but also fat and auxiliary substances can be administered to the young stock without this leading to digestive problems when large quantities of fat (about 45 wt. %) are used.

The device according to the invention consists of a mixer comprising a supply inlet for the basic component on the one hand and fat on the other hand, from which mixer the fat-containing basic component can be discharged. Said device is characterized in that the material supplied as the basic component is a milk substitute and in that the mixer comprises a vacuum pump.

Furthermore it is preferred to supply the product to be discharged from the mixer, via a screen and an apparatus for reducing chunks, to a second screen and to cool the final product before storage thereof. Preferably, the device according to the invention comprises a supply inlet for carbon dioxide in connection with said cooling.

1. A fat-containing milk substitute for young stock, such as calves, and for poultry, consisting of a particulate basic component which contains fat, characterized in that more than 50 wt. % of the fat has been introduced into the capillaries of the basic component, with less than 50 wt. % of the fat being present at the surface of the particles of the basic component.

2. A fat-containing milk substitute according to claim 1, characterized in that said basic component is a powder.

3. A fat-containing milk substitute according to claim 1, characterized in that more than 90 wt. % of the fat has been introduced into the capillaries of the basic component, with less than 10 wt. % of the fat being present at the surface of the particles of the basic component.

4. A fat-containing milk substitute according to claim 2, characterized in that said powder is a milk powder.

5. A method for preparing a fat-containing milk substitute for young stock, such as calves, by mixing fat with the particles of the basic component of the milk substitute, characterized in that more than 50 wt. % of the fat is introduced into the capillaries of the basic component, with less than 50 wt. % of the fat being present at the surface of the particles of the basic component.

6. A method according to claim 5, characterized in that said basic component is a powder.

7. A method according to claim 5, characterized in that the basic component/fat weight ratio ranges between 1:0.5 and 1:0.1.

8. A method according to claims 5, characterized in that the fat is mixed with the powder under a reduced pressure and at an elevated temperature.

9. A method according to claim 7, characterized in that the powder/fat weight ratio ranges between 1:0.5 and 1:0.1.

10. A method according to claim 8, characterized in that the reduced pressure is 0.2-0.7 bar.

11. A method according to claim 8, characterized in that the the elevated temperature is 25-60° C.

12. A method according to claims 5, characterized in that the fat-containing particles are screened to a particle size of 0.5-4 mm.

13. A method according to claim 12, characterized in that the granulated particles are stored at a temperature of less than 8° C.

14. A method according to claim 13, characterized in that said cooling takes place by mixing the fat-containing product with solid carbon dioxide and causing the carbon dioxide to evaporate by ventilating air passing said solid carbon dioxide.

15. A device for carrying out the method according to claim 5-14, which device consists of a mixer comprising a supply inlet for basic component and fat and an outlet for the mixture of basic component and fat, characterized in that the basic component has been selected so that a milk substitute can be obtained therewith and in that the mixer (3) comprises a vacuum pump (5).

16. A device according to claim 15, characterized in that the outlet (11) of the mixer opens onto a screen (13). after which screen a milling cutter (15) is disposed for crushing the large chunks fine, after which milling cutter a flat screen/fluidising bed (18) provided with a cooling element for obtaining a cooled final product is disposed.

17. A device according to claim 16, characterized in that a supply inlet for carbon dioxide is present between the screen (13) and the flat screen (18) so as to obtain a coolant.
